(19) United States
(12) Patent Application Publication
(10) Pub. No.: US 2006/0207233 A1
(43) Pub. Date: Sep. 21, 2006

(54) Filter installation method and apparatus

(75) Inventors: Christopher A. Hord, Vancouver, WA (US); David Lawson, Vancouver, WA (US)

Correspondence Address: MCNEES, WALLACE & NURICK LLC, 100 PINE STREET, P.O. BOX 1166, HARRISBURG, PA, 17108-1166, US

(73) Assignee: YORK INTERNATIONAL CORPORATION, York, PA (US)

(21) Appl. No.: 11/376,967

(22) Filed: Mar. 16, 2006

Related U.S. Application Data
(60) Provisional application No. 60/663,089, filed on Mar. 18, 2005.

(51) Int. Cl. B01D 50/00

(52) U.S. Cl. 55/482

(57) ABSTRACT

The present invention also includes a method for installing filters, particularly HEPA filters, into an air handling unit. The method includes providing a filter and a positioning frame, the positioning frame having a geometry that positions the filter adjacent to the frame. The positioning frame also has a latching mechanism for attaching the positioning frame and filter to the filter cabinet. The method further includes positioning the filter and the positioning frame into an opening in a filter cabinet. The frame is then secured to the cabinet by the latching mechanism where the latching mechanism provides a force to the positioning frame and filter, sealing the filter against the filter cabinet to help prevent the flow of air around the filter.

### FIELD OF THE INVENTION

The present invention is directed to a method and apparatus for installing filters for air handling unit in HVAC systems.

### BACKGROUND OF THE INVENTION

Air handling unit for HVAC systems typically employ a filter arrangement for removing particles from the air. Some known filter applications include specialized filters that remove contaminants from the air, such as biological and/or chemical pollutants. To remove chemical pollutants, activated carbon or activated alumina adsorbing filters, may be used to adsorb chemical pollutants present in the air in order to neutralize the chemical pollutant. The adsorbing filters must be replaced periodically to maintain their effectiveness. To remove biological pollutants from the air, a high efficiency particulate air (HEPA) filter is used. HEPA filters remove at least 99.97% of contaminants that have a size of 0.3 microns or larger. These HEPA filters have been utilized to remove biological agents from the air. Like the adsorbing filters, the HEPA filters must be replaced periodically to maintain their effectiveness.

Installation of the activated carbon or activated alumina and HEPA filters have typically taken place through the side of the unit. Large sections of filters are hoisted through an opening in the side of the air handling unit. The filters are then positioned and sealed using mechanical positioning devices. The known method of installing filters suffers from several drawbacks. One drawback of the known method includes the requirement of the mechanical positioning devices for each bank of the adsorbing filters and HEPA filters. These mechanical positioning devices require additional structural material, such as metal, adding weight, bulk and cost to the filter system. In addition, the filter housing, including a stainless steel casing, and a filter access door, previously required for HEPA filters, are required for installation of the filters. An additional drawback is that the filter banks are heavy and typically require the assistance of a forklift or other lifting device. Still another drawback of the known system is that the banks of HEPA filters are replaced through a single opening. The HEPA filters are typically installed in banks of three, where one filter is placed into the unit and subsequent filters are placed adjacent to the first. A force is placed on the side of the filters in order to seal each the filters and substantially prevent leakage of airflow around the filters. If a single HEPA filter is damaged or is not functioning correctly, the entire bank of HEPA filters must be replaced because the seal between the filters must be released in order to replace the filter. Once a seal on a HEPA filter is released, the filter generally must be replaced in order to ensure that the seal is the original factory seal between the filters and is adequate to prevent leakage. Still another drawback of the known system is that the airway length is extended, requiring additional space, weight, material at a greater cost.

What is needed is a method for installing filters for air handling unit and an apparatus for installing filters for air handling unit that does not suffer from the drawbacks of the prior art.

### SUMMARY OF THE INVENTION

The present invention includes a positioning frame for positioning and sealing a filter into a filter cabinet in an air handling unit for an HVAC system. The positioning frame includes a filter frame for retaining a first filter, preferably a prefilter. The positioning frame further including a first and second frame stiffening locator attached to a first and second end of the filter frame. The first and second frame stiffening locators have a geometry that positions a second filter adjacent to the positioning frame. One or both of the first and second frame stiffening locators have one or more flanges extending from a surface of the first and second frame stiffening locators. Each of the flanges including an attachment device for attaching the positioning frame to a filter cabinet. The attachment device is configured to attach the positioning frame to the cabinet and seal the second filter into the filter cabinet to prevent airflow from traveling around the second filter.

The present invention also includes a filter cabinet for retaining filters in an air handling unit for an HVAC system. The cabinet according to the present invention positions and seals filters, preferably HEPA filters, into a filter cabinet in an air handling unit. The filter cabinet includes a flange portion that extends in a first plane outward from one or more openings configured to receive filters. The flange portion has a geometry that substantially prevents the flow of air around filters positioned in the cabinet. The cabinet further includes one or more attachment devices arranged and disposed on the first plane of the filter cabinet capable of attaching to a positioning frame for positioning a filter. The opening or openings along the flange portion include a duct extending perpendicularly from the first plane having a geometry that retains and seals the filter to substantially prevent air from flowing around the filter.

The present invention also includes a method for installing filters, particularly HEPA filters, into an air handling unit. The method includes providing a filter and a positioning frame. The positioning frame has a geometry that positions the filter adjacent to the frame. The positioning frame also has a latching mechanism for attaching the positioning frame and filter to the filter cabinet. The method further includes positioning the filter and the positioning frame into an opening in the filter cabinet. The frame is then secured to the cabinet by the latching mechanism where the latching mechanism provides a force to the positioning frame and filter, sealing the filter against the filter cabinet to help prevent the flow of air around the filter.

In another embodiment of the present invention, the positioning frame further includes a hinge that is capable of attachment to the filter cabinet that permits pivotal rotation of the positioning frame sufficient to permit installation and removal of the HEPA filter.

An advantage of the installation method and apparatus of the present invention is that the mechanical positioning devices required for the bank of HEPA filters is not required for the individual filter installations of the present invention. In addition, the apparatus to maintain the seal in the HEPA filter bank is not required. Therefore, filter cabinet of the present invention is smaller, requiring less cabinet material, achieving reduced weight and cost.

An additional advantage of the installation method and apparatus of the present invention is that the HEPA filters can be installed individually. The individual installation of the HEPA filters allows replacement of an individual filter, while retaining an original seal, instead of the whole bank of filters, if one filter is damaged or is not functioning correctly. The ability to replace single filters also allows the maximizing of the useful life of the individual HEPA filters.

An additional advantage of the installation method and apparatus of the present invention is that the airway length of the filter is reduced, achieving reduced weight, space, and manufacturing material.

Other features and advantages of the present invention will be apparent from the following more detailed description of the preferred embodiment, taken in conjunction with the accompanying drawings which illustrate, by way of example, the principles of the invention.

### BRIEF DESCRIPTION OF THE DRAWINGS

FIG. 1 schematically illustrates an elevational side cross-sectional view of an air handling unit according to the present invention.

FIG. 2 schematically illustrates a top cross-sectional view of an air handling unit according to the present invention.

FIG. 3 is a perspective view of a positioning frame according to the present invention.

FIG. 4 is a elevational front view of a positioning frame according to the present invention.

FIG. 5 is an elevational side view of a positioning frame according to the present invention.

FIG. 6 is an elevational side view of a filter cabinet according to the present invention.

FIG. 7 is a elevational front view of a filter cabinet according to the present invention.

FIG. 8 is a perspective view of the alternate embodiment according to an alternate embodiment of the present invention.

FIG. 9 is an elevational front view of a positioning frame according to the alternate embodiment of the present invention.

FIG. 10 is an elevational side view of a positioning frame according to the alternate embodiment of the present invention.

FIG. 11 is a elevational side view of a filter cabinet according to an alternate embodiment of the present invention.

FIG. 12 is a elevational front view of a filter cabinet according to the alternate embodiment of the present invention.

Wherever possible, the same reference numbers will be used throughout the drawings to refer to the same or like parts.

### DETAILED DESCRIPTION OF THE INVENTION

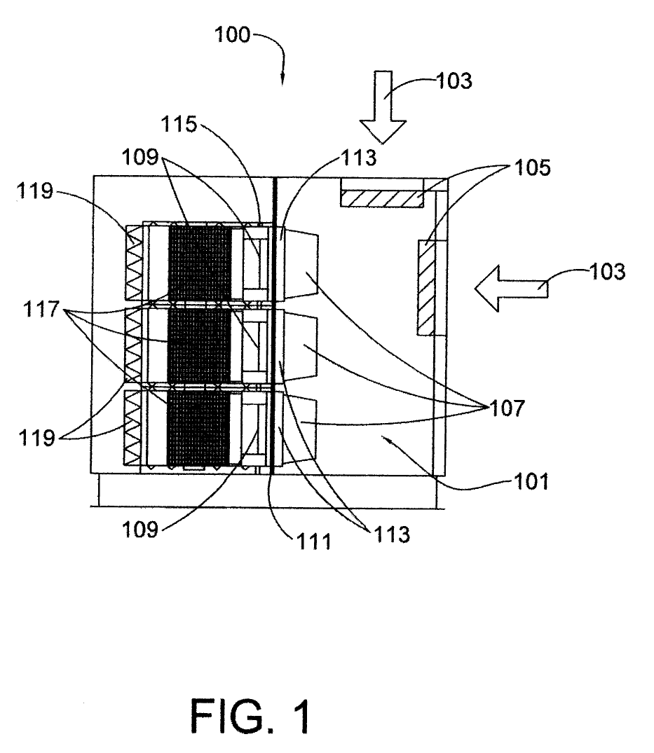

FIG. 1 shows a side view of an air handling unit 100 having a filter arrangement according to one embodiment of the present invention. Airstreams 103 flow through dampers 105 into mixing box 101. Airstreams 103 can be a mixture of return air from an interior space, outdoor air or a mixture thereof. Airstreams 103 are mixed in the mixing box 101 prior to entering prefilters 107. Prefilters 107 remove larger particles from the air prior to entering HEPA filters 109. Air from the mixing box 101 is prevented from flowing around the prefilters 107 and HEPA filters 109 by a flange 111. Flange 111 extends from the outer walls at the air handling unit 100 and forces the air to flow into prefilters 107 and HEPA filters 109 and substantially prevents air from flowing around prefilters 107 and HEPA filters 109. Prefilters 107 are held in place by a positioning frame 113. Positioning frame 113 is releasably attached to filter cabinet 115 and provides a force against HEPA filter 109, such that the HEPA filter 109 is secured within an opening in filter cabinet 115 and seals against filter cabinet 115. Sealing against the filter cabinet 115 provides a substantially airtight seal that forces air through the HEPA filter 109 and substantially prevents air from bypassing or flowing around the HEPA filter 109. Flange 111 is attached to filter cabinet 115. Filter cabinet 115 includes a duct (not shown) that extends substantially perpendicularly from flange 111 in a direction opposite of mixing box 101. In one embodiment, the duct of filter cabinet 115 is arranged to secure HEPA filters 109 and adsorbing filters 117, while substantially preventing the bypassing of around the HEPA filters 109 and the adsorbing filters 117. The geometry of the duct preferably includes a geometry that is capable of receiving at least a portion of the HEPA filter. The geometry of the duct may be any suitable geometry including, but not limited to geometries having a rectangular cross-section, an oval cross-section or circular cross-section. In addition to prefilter 107, the HEPA filter 109, the adsorbing filter 117, additional filters, such as postfilters 119, may be secured to filter cabinet 115. Postfilters 119 are filters that are temporarily installed in order to remove excess carbon that may be present in the air during the startup of the air handling unit 100. Filtered air leaves the postfilters 119 and returns to the conditioned space through the HVAC system. The air treated by the HEPA filters 109 and adsorbing filters 117 is substantially free of chemical and biological pollutants.

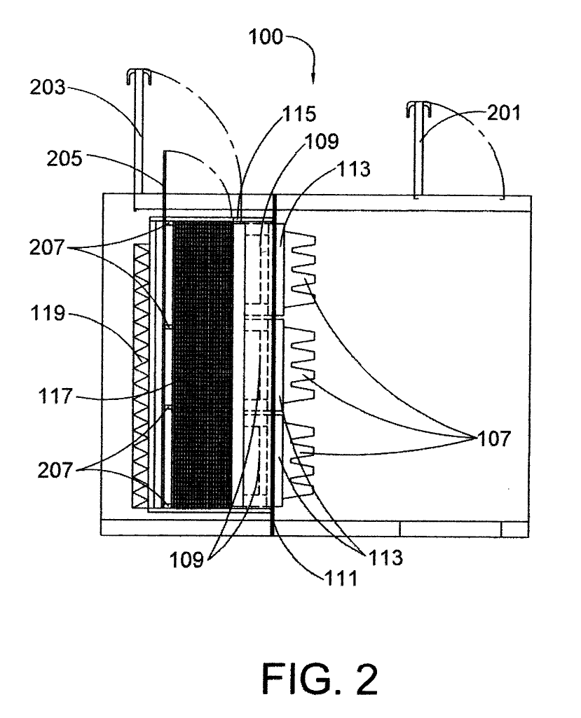

FIG. 2 shows a top view of an air handling unit 100 having a filter arrangement according to one embodiment of the present invention, FIG. 2 shows the mixing box 101, the prefilters 107, the HEPA filters 109, the flange 111, the positioning frame 113, the filter cabinet 115, the adsorbing filter 117 and the postfilters 119, as described above with respect to FIG. 1. In addition, FIG. 2 shows the access doors 201 and 203 through which the adsorbing filters 117 and the HEPA filters 109 are replaced. Adsorbing filter access door 203 provides access to the adsorbing filters 117. To access the adsorbing filters 117, adsorbing filter access door 203 is opened to expose one side of the adsorbing filters 117. A mechanical arm 205 is rotated to release the adsorbing filters 117. As the mechanical arm 205 rotates, a mechanical positioning device 207 disengages the adsorbing filters 117, which releases the seal for the adsorbing filters 117 and allows the filters to be removed through the adsorbing filter access door 203. With respect to HEPA filters 109, access door 201 provides access to the mixing box 101 to replace the HEPA filters 109. Inside the mixing box 101, the HEPA filters 109 are installed individually into the filter cabinet 115 from inside the mixing box 101. Individual filters have a weight that is sufficiently low for manual installation by a human installer. The positioning frame 113 is fastened to the filter cabinet 115 and provides a force on the HEPA filters 109 sufficient to seal the HEPA filters 109 against the filter cabinet 115. The mechanical arm 205 and mechanical positioning device 207 are not required to position the HEPA filters 109, permitting the filter cabinet 115 to be smaller, less weight and requiring less filter cabinet material than in frames previously used to hold filter assemblies.

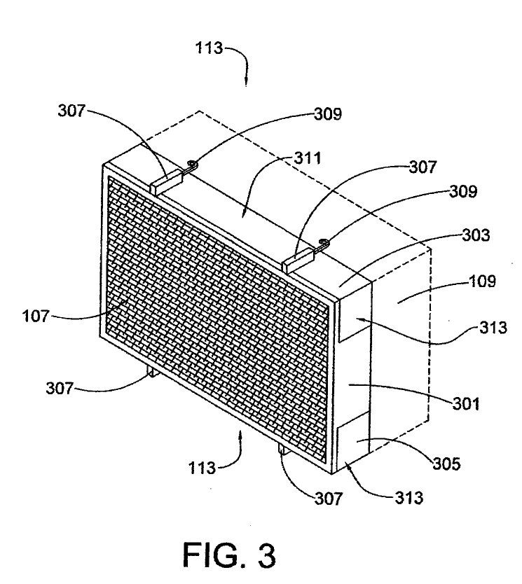

FIG. 3 shows a positioning frame 113 according to an embodiment of the present invention. When installed, the positioning frame 113 is adjacent to HEPA filter 109 and includes a filter frame 301, which secures prefilters 107. The positioning frame 113 also includes a first frame stiffening locator 303 and a second frame stiffening locator 305. The first frame stiffening locator 303 and second frame stiffening locator 305 are preferably attached to opposite ends of the filter frame 301. The first and second frame stiffening locators 303 and 305 attach and cover a portion of the surface of the filter frame 301. The first and second frame stiffening locators 303 and 305 each include a substantially planar attachment surface 311 and a substantially planar side surface 313. The attachment surface 311 includes a portion that extends along the plane of the surface 311 in the direction of the HEPA filters 109 for a length sufficient to align the HEPA filters 109 adjacent to the positioning frame 113. Likewise, the side surfaces 313 extend in the direction of HEPA filters 109 in order to align the HEPA filters 109 adjacent to the positioning frame 113. While FIG. 3 shows attachment surfaces 311 and side surfaces 313, the present invention may include a single attachment surface 311 on each of the first and second frame stiffening locators 303 and 305 in order to align the HEPA filters 109 adjacent to the positioning frame 113.

As shown in FIG. 3, the first frame stiffening locator 303 includes an attachment flange 307. The attachment flange 307 includes latching mechanism 309. Although FIG. 3 depicts a latching mechanism 309 attached to attachment flange 307, any suitable attachment device may be used with the present invention, so long as the attachment device is capable of attaching to filter cabinet 115 and providing a force against HEPA filters 109 sufficient to seal the HEPA filters 109 against the filter cabinet 115. Although FIG. 3 shows a pull-latch, any suitable latching device may be utilized. The second frame stiffening locator 305 includes substantially the same arrangement of attachment flange 307 and latching mechanism 309, as described with respect to the first frame stiffening locator 303. While FIG. 3 shows two attachment flanges 307 for each of the first and second frame stiffening locators 303 and 305, any number of attachment flanges 307 may be used, so long as the attachment flanges 307 and latching mechanisms 309 secure the HEPA filters 109 to the filter cabinet 115 and provide a force on the HEPA filters 109 sufficient to seal the HEPA filters 109 against the filter cabinet 115. Attachment flanges and attachment devices as herein defined include any structure extending from the first and/or second frame stiffening locator 303 and 305 capable of attaching or pivoting alone or in combination with a latching mechanism 309 to the filter cabinet 115.

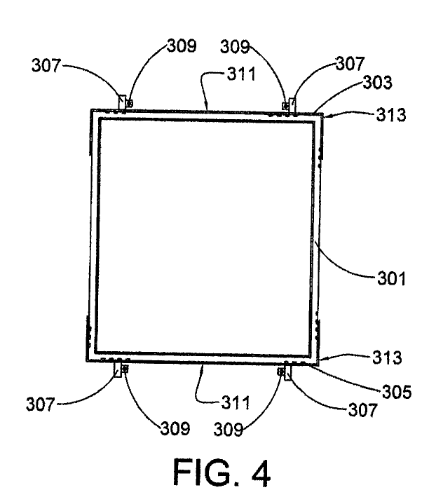

FIG. 4 shows a front elevational view of the embodiment shown in FIG. 3. As shown in FIG. 4, the first and second frame stiffening locators 303 and 305 each include attachment flanges 307 and latching mechanisms 309. Each of the first and second frame stiffening locators 303 and 305 include attachment surface 311 and side surface 313.

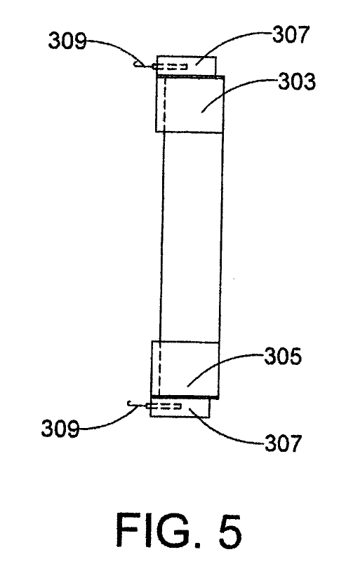

FIG. 5 shows a side elevational view of the embodiment shown in FIG. 3. As shown in FIG. 5, the first and second frame stiffening locators 303 and 305 include surfaces extending from the filter frame 301. The surface extending from the filter frame 301 is configured to provide positioning support for HEPA filters 109 (not shown in FIG. 5).

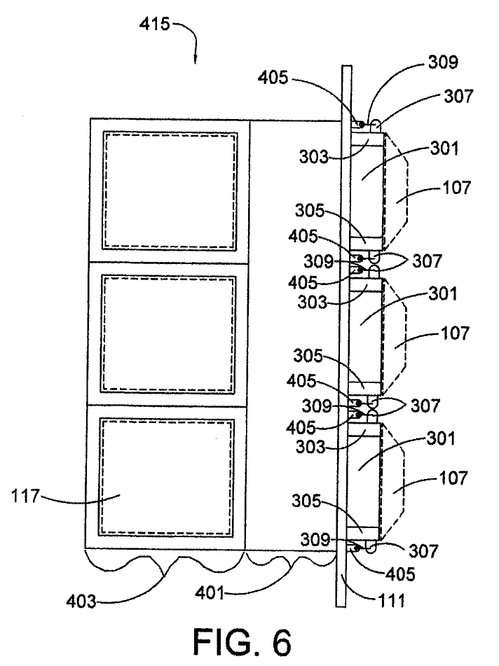

FIG. 6 shows a side elevational view of a filter cabinet 115 according to one embodiment of the present invention. FIG. 6 shows a filter frame 301 having first and second frame stiffening locators 303 and 305 installed on the filter cabinet 115. The first and second frame stiffening locators 303 and 305 include attachment flanges 307 and the latching mechanisms 309, as described above in the discussion of FIG. 3. FIG. 6 also shows filter cabinet 115 including flange 111, a HEPA filter section 401, which includes HEPA filters 109 (not shown in FIG. 6) and an adsorbing filter section 403, which includes adsorbing filters 117. Flange 111 includes attachment devices 405 attached to the flange 111 and extending away from the surface of flange 111 in a direction opposite the direction of the HEPA filter section 401. The attachment devices 405 may include any device that is suitable for receiving latching mechanisms 309.

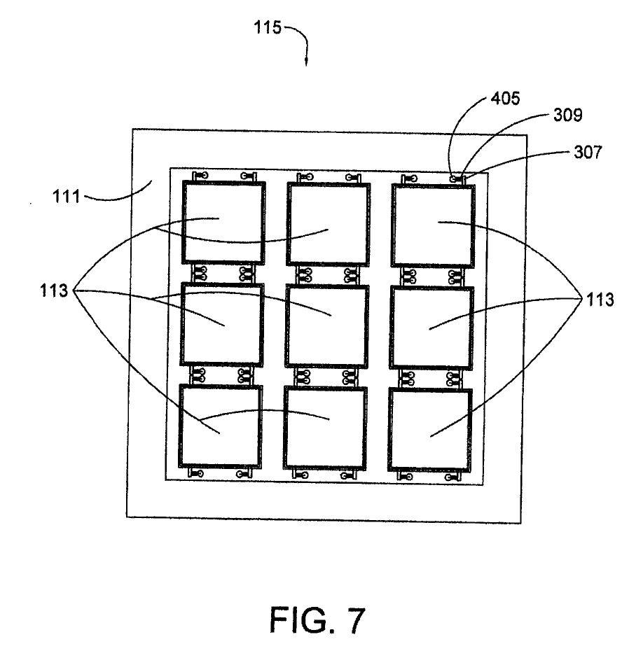

FIG. 7 shows a front elevational view of filter cabinet 115, as viewed from a mixing box 101 of air handling unit 100, according to one embodiment of the invention. FIG. 7 shows nine positioning frames 113, which secure nine HEPA filters 109. Although FIG. 7 shows nine HEPA filters 109, any number of filters may be used, depending on the application and space restrictions of the air handling unit 100. The attachment flanges 307 on the positioning frame 113 includes latching mechanisms 309, which attach to corresponding attachment devices 405. Although FIG. 7 shows placement of the four sets of attachment flanges 307, latching mechanisms 309 and attachment devices 405 for each positioning frame 113 as one set substantially in each corner of the positioning frame 113, any arrangement of attachment flanges 307, latching mechanisms 309 and attachment devices 405 may be used so long as the positioning frame 113 attaches to the filter cabinet 115 and provides a force against the HEPA filter 109 sufficient to seal the HEPA filter 109 against the filter cabinet.

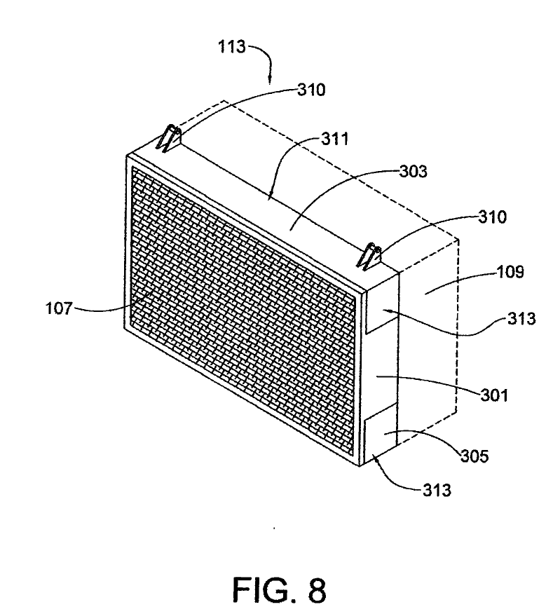

FIG. 8 shows a positioning frame 113 according to an alternate embodiment of the present invention. When installed, the positioning frame 113 is adjacent to HEPA filter 109 and includes a filter frame 301, which secures prefilter 107. The positioning frame 113 also includes a first frame stiffening locator 303 and a second frame stiffening locator 305. The first frame stiffening locator 303 and a second frame stiffening locator 305 are preferably attached to opposite ends of the filter frame 301. The first and second frame stiffening locators 303 and 305 attach and cover a portion of the surface of the filter frame 301. Unlike the embodiment shown in FIG. 3, this embodiment includes a second frame stiffening locator 305 having an attachment surface 311 and no side surface 313. The first frame stiffening locator 303 in the embodiment shown in FIG. 8 includes an attachment surface 311 and a side surface 313. The attachment surface 311 includes a portion that extends along the plane of the attachment surface 311 in the direction of the HEPA filter 109 for a length sufficient to align HEPA filter 109 adjacent to the positioning frame 113.

FIG. 8 also shows an alternate arrangement of attachment flanges 307 and latching mechanisms 309. The first frame stiffening locator 303 includes hinges 310 which pivotably attach to filter cabinet 115. The second frame stiffening locator 305 includes attachment flanges 307 and latching mechanism 309. Attachment flanges 307 and latching mechanisms 309 form a unitary component capable of releasably engaging the filter cabinet 115.

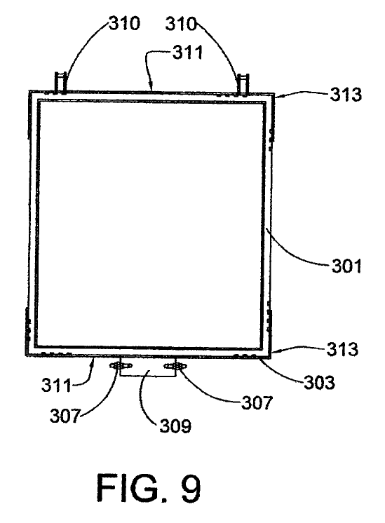

FIG. 9 shows a front elevational view of the embodiment shown in FIG. 8. As shown in FIG. 9, the second frame stiffening locator 305 includes a unitary attachment flange 307 and latching mechanism 309. The latching mechanism is preferably a spring latch capable of manual release. Although the mechanism shown in FIGS. 8-12 is a spring latch, any suitable latching mechanism may be utilized to provide a detachable engagement that permits removal of the HEPA filter 109. The first frame stiffening locator 303 includes attachment surface 311 and side surface 313, while the second frame stiffening locators 305 includes only the attachment surface. As discussed above with respect to the embodiment shown in FIGS. 3-7, the arrangement of attachment surface 311 and side surfaces 313 may be any arrangement that permits positioning of the HEPA filter 109 and supports the filter frame 301.

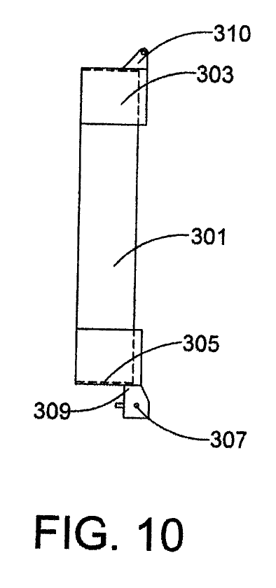

FIG. 10 shows a side elevational view of the embodiment shown in FIG. 8. As shown in FIG. 10, the first and second frame stiffening locators 303 and 305 include surfaces extending from the filter frame 301. The surface extending from the filter frame 301 provides positioning support for HEPA filters 109 (not shown in FIG. 10).

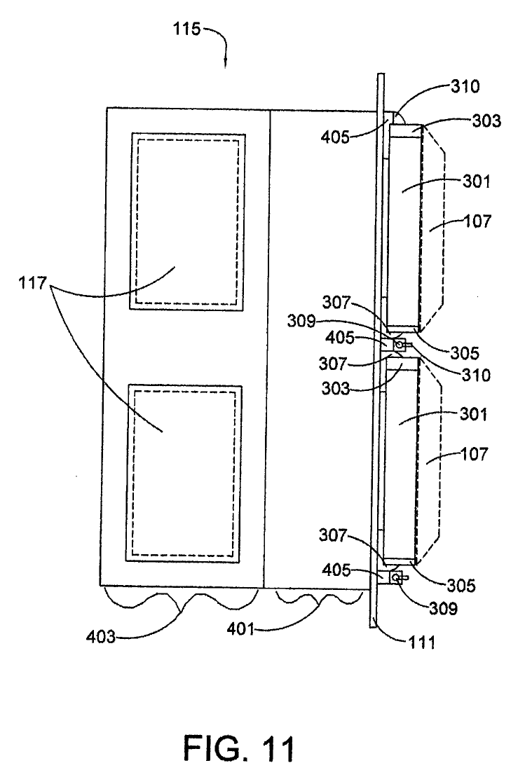

FIG. 11 shows a side elevational view of a filter cabinet 115 according to an alternate embodiment of the present invention. FIG. 11 shows a filter frame 301 having first and second frame stiffening locators 303 and 305 installed on the filter cabinet 115, as shown and described above with respect to FIG. 3. FIG. 11 also shows filter cabinet 115 including flange 111, a HEPA filter section 401, which includes HEPA filters 109 (not shown in FIG. 11) and an adsorbing filter section 403, which includes adsorbing filters 117, also shown and described above with respect to FIG. 3. However, the embodiment shown in FIG. 11 includes hinge 310 attached to filter cabinet 115 at one end of the filter frame 301 by the first frame stiffening locator 303. The second frame stiffening locator 305 includes a latching mechanism that detachably engages the filter cabinet 115.

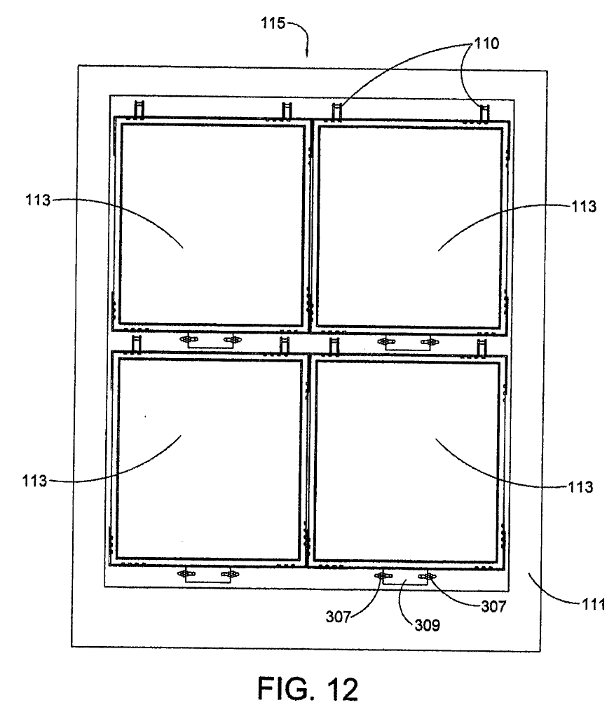

FIG. 12 shows a front elevational view of filter cabinet 115, as viewed from a mixing box 101 of air handling unit 100, according to one embodiment of the invention. FIG. 12 shows four positioning frames 113, which secure four HEPA filters 109. Although FIG. 12 shows four HEPA filters 109, any number of filters may be used, depending on the application and space restrictions of the air handling unit 100. The attachment flanges 307 and latching mechanisms 309 on the positioning frame 113, which attach to corresponding attachment devices 405. Hinge 310 pivotably attaches to filter cabinet 115 and permits sufficient pivotal rotation to facilitate installation and removal of the HEPA filter 109. Although FIG. 12 shows placement of the one set of attachment flanges 307, latching mechanisms 309 and attachment devices 405 and two hinges 310 for each positioning frame 113, any arrangement of attachment flanges 307, latching mechanisms 309 and attachment devices 405 and hinges 310 may be used so long as the positioning frame 113 attaches to the filter cabinet 115 and provides a force against the HEPA filter 109 sufficient to seal the HEPA filter 109 against the filter cabinet.

While the invention has been described with reference to a preferred embodiment, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

1. A positioning frame for positioning and sealing a filter into a filter cabinet in an air handling unit for an HVAC system comprising:
a filter frame for retaining a first filter,
a first and second frame stiffening locator attached to a first and second end of the filter frame, the first and second frame stiffening locators have a geometry that positions a second filter adjacent to the positioning frame;
one or more flanges extending from a surface of one or both of the first and second frame stiffening locators, the flange including an attachment device for attaching the positioning frame to a filter cabinet, the attachment device being configured to attach the positioning frame to the cabinet and seal the second filter into the filter cabinet to prevent airflow from bypassing the second filter.

2. The positioning frame of claim 1, wherein the filter frame is configured to receive a prefilter.

3. The positioning frame of claim 1, wherein the first and second frame stiffening locators are configured to position a HEPA filter.

4. The positioning frame of claim 1, wherein the attachment device includes a device that provides force on the second filter.

5. The positioning frame of claim 1, wherein the flange and attachment device are a unitary component.

6. The positioning frame of claim 1, further comprising a hinge extending from one or both of the first and second frame stiffening locators capable of pivotably attaching to the filter cabinet.

7. A filter cabinet for retaining filters in an air handling unit for an HVAC system comprising:
a cabinet having a flange portion that extends in a first plane outward from one or more openings in the cabinet configured to receive one or more of a first filter or a second filter, the flange portion includes a geometry that substantially prevents the bypassing of air around the filter positioned in the cabinet;
one or more attachment devices arranged and disposed on a surface of the filter cabinet capable of attaching a positioning frame for positioning a filter;
wherein the opening or openings along the flange portion includes a duct extending perpendicularly from the first plane having a geometry that retains and seals the filter to substantially prevent air from bypassing the filter.

8. The filter cabinet of claim 7 wherein the positioning frame includes a filter frame for retaining a first filter,
a first and second frame stiffening locator attached to a first and second end of the filter frame, the first and second frame stiffening locators have a geometry that positions a second filter adjacent to the positioning frame; and
one or more positioning frame flanges extending from a surface of one or both of the first and second frame stiffening locators, the positioning frame flange including an positioning frame attachment device for attaching the positioning frame to the filter cabinet, the positioning frame attachment device being configured to detachably engage the positioning frame to the cabinet and seal the second filter into the filter cabinet to prevent airflow from bypassing the second filter.

9. The cabinet of claim 8, wherein the filter frame is configured to receive a prefilter.

10. The cabinet of claim 8, wherein the first and second frame stiffening locators are configured to position a HEPA filter.

11. The cabinet of claim 8, wherein the attachment device includes a device that provides force on the second filter.

12. The positioning frame of claim 8, wherein the flange and attachment device are a unitary component.

13. The positioning frame of claim 8, further comprising a hinge extending from one or both of the first and second frame stiffening locators capable of pivotably attaching to the filter cabinet.

14. The cabinet of claim 8, further comprising a frame configured to support a postfilter.

15. The cabinet of claim 7, further comprising a mechanical positioning device configured to position and retain an adsorbing filter.

16. A method for installing HEPA filters into an air handling unit comprising:
providing a filter and a positioning frame, the positioning frame having a geometry that positions the filter adjacent to the frame and having a latching mechanism for attaching the positioning frame and the filter to a filter cabinet;
positioning the filter and the positioning frame into an opening in the filter cabinet;
securing the positioning frame and the filter to the filter cabinet with the latching mechanism by providing a force to the positioning frame and filter, sealing the filter against the filter cabinet to help prevent the flow of air around the filter.

17. The method of claim 16, wherein positioning includes inserting the filter into the opening from a direction perpendicular to a surface of the filter cabinet.

18. The method of claim 16, wherein securing includes providing sufficient force on a seal on the filter cabinet to substantially prevent the bypass of air around the filter.

19. The method of claim 16, wherein securing includes engaging the latching mechanism with an attachment device on a surface of the filter cabinet.

20. The method of claim 16, wherein securing further includes pivoting the positioning frame about a hinge attached to the filter cabinet and engaging a latching mechanism to detachable engage the attachment device.

21. The method of claim 16, wherein the method further includes positioning a prefilter in the positioning frame.

22. The method of claim 16, wherein the filter cabinet includes a plurality of openings.

23. The method of claim 16, wherein positioning and securing a filter may be performed individually with each of the plurality of opening.
